(19) United States
(12) Patent Application Publication
(10) Pub. No.: US 2013/0085809 A1
(43) Pub. Date: Apr. 4, 2013

(54) System, Apparatus and Method for Customer Requisition and Retention Via Real-time Information

(71) Applicant: InterfaceIT Operations Pty. Ltd., Richmond (AU)

(72) Inventor: Jordan Kendall Muir, Dallas, TX (US)

(73) Assignee: InterfaceIT Operations Pty. Ltd., Richmond (AU)

(21) Appl. No.: 13/631,172

(22) Filed: Sep. 28, 2012

Related U.S. Application Data
(60) Provisional application No. 61/540,582, filed on Sep. 29, 2011.

(51) Int. Cl. G06Q 30/02

(52) U.S. Cl. 705/7.34

(57) ABSTRACT

A hand-held computing device and system is provided comprising an executable method for providing the user the ability to allocate geographical regions to a predetermined or on-the-fly representative or groups of representatives. The executable method in conjunction with the hand-held computing device provides a field representative with the means to view a predetermined allocation of customer's houses or business addresses that are part of scheduled daily activity. The system provides user ability to access a particular property, display information at the point-of-sale, capture information including digital signatures and verbal verifications, and storing the outcome of the interaction in a particular case. A user interface on a hand-held computer device is provided that includes a group management module, a user allocation module, a team leader module, a customer interaction module, and a mapping module. A further user interface is provided at one or more web consoles. Said web console user interface includes a form builder module, a form management module, a reporting module, and an allocation module.

### CROSS-REFERENCE TO RELATED APPLICATIONS

This application is based on and claims priority to U.S. provisional patent application Ser. No. 61/540,582 filed on Sep. 29, 2011 and entitled “System, Apparatus and Method for Customer Requisition and Retention via Real Time Information,” the entire contents of which are hereby incorporated by reference.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

1. Field of the Invention

This invention relates to a method, system and device for customer requisition and retention data profiling. More particularly, to a method, system and device for implementation on hand-held computer devices for providing sales personnel with customer requisition and retention data via real-time information and for processing transactions in the field while facilitating door-to-door sales.

2. Description of Related Art

Historically, products sold door-to-door are of the same variety that can be purchased at large retail or discount stores. The products accounting for the largest share of direct-sales revenue include cleaning supplies, cleaning equipment, appliances, magazine subscriptions, and home improvement products. The largest subset of these would be the home improvement products/services where items sold could be new or repaired roofs, siding, new replacement windows, and decorative stone. The business model of many companies that participate in this type of direct marketing has changed with the growth of the Information Age. Products and services sold door-to-door are now more likely to be more subtle in nature, such as coupons to events or local businesses, season tickets to local professional sports teams or subscriptions to home television services or broadband internet services. Telecommunications companies all contract with various marketing companies for nationwide sales fulfillment at the residential level. While the older model of the salesman carrying a bag of goods on his shoulder to sell to the public still can occasionally be seen, today's salesmen specialize in the newer field of customer account execution, retention or requisition.

Many door-to-door salesmen currently carry pen and paper forms in order to capture information from a customer during an interaction. After the salesman has captured such customer information, the data must be entered into a computer system at a later time. Allocation of geographical regions to a representative or a group of representatives must currently be done prior to any dispatch of sales representatives and may not easily be manipulated on the fly. Property and demographic information related to a representative's allocations must currently be carried in paper form and may not be updated on the fly.

### BRIEF SUMMARY OF THE INVENTION

Accordingly, in one embodiment of the present invention, a hand-held computing device is provided comprising an executable method for providing the user the ability to allocate geographical regions to a predetermined or on-the-fly representative or groups of representatives.

In another embodiment, the executable method in conjunction with the hand-held computing device also provides field representatives with the means to view their pre-determined geographical allocation. In addition, representatives are provided with the ability to access a particular property, display information at the point-of-sale, capture information including digital signatures and verbal verifications, and storing the outcome of the interaction in a particular case.

### BRIEF DESCRIPTION OF THE SEVERAL VIEWS OF THE DRAWINGS

The foregoing summary, as well as the following detailed description, will be better understood when read in conjunction with the appended drawings. For the purpose of illustration, there is shown in the drawings certain embodiments of the present disclosure. It should be understood, however, that the invention is not limited to the precise arrangements and instrumentalities shown.

In the drawings:

FIG. 1 is a flow diagram illustrating an embodiment of the method implemented by a system on a hand-held computing device comprising a backend function for processing a transaction directly into a customer relationship management (CRM) system via a hand-held computing device according to the present disclosure.

FIG. 2 is an example display screen provided via the web console in connection with the preferred embodiment of the present invention.

FIG. 3 is an example display screen provided via the web console in connection with the preferred embodiment of the present invention.

FIG. 4 is an example display screen provided via the web console in connection with the preferred embodiment of the present invention.

FIG. 5 is an example display screen provided via the web console in connection with the preferred embodiment of the present invention.

FIG. 6 illustrates an example display screen provided to a user via a hand-held device in connection with the preferred embodiment of the present invention.

FIG. 7 is an example display screen provided via the web console in connection with the preferred embodiment of the present invention.

FIG. 8 is an example display screen provided via the web console in connection with the preferred embodiment of the present invention.

FIG. 9 is an example display screen provided via the web console in connection with the preferred embodiment of the present invention.

FIG. 10 is an example display screen provided via the web console in connection with the preferred embodiment of the present invention.

### DETAILED DESCRIPTION OF THE INVENTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It should be understood that any one of the features of the invention may be used separately or in combination with other features. Other systems, methods, features, and advantages of the present invention will be or become apparent to one with skill in the art upon examination of the drawings and the detailed description. It is intended that all such additional systems, methods, features, and advantages be included within this description, be within the scope of the present invention, and be protected by the accompanying claims.

The following discussion is presented to enable a person skilled in the art to make and use the present invention. The general principles described herein may be applied to embodiments and applications other than those specifically detailed below without departing from the spirit and scope of the present invention. Therefore, the present invention is not intended to be limited to the embodiments expressly shown, but is to be accorded the widest possible scope of invention consistent with the principles and features disclosed herein.

The present disclosure provides an enterprise grade computer application implemented in conjunction with and by a hand-held computing device such as, but not limited to, the Apple® iPad® and designed for processing transactions including transactions associated with market research and analysis and for transactions in the field while sales personnel facilitate door-to-door sales including, but not limited to, sales of electricity, natural gas, telecommunication services and internet services among others. One skilled in the art will recognize that the present system and devices have application across numerous offerings of services, all of which are not mentioned herein.

In at least one embodiment there are three primary functions: 1) providing team managers with the ability to allocate geographic regions to groups of representatives (door-to-door sales); and 2) providing field representatives with the means to view their allocation (i.e., the houses/addresses that are part of their daily activity); 3) providing sales representatives with the ability to access a property, display information at the point-of-sale, capture information including digital signatures and verbal verifications, and storing the outcome of an interaction in each particular case; and 4) provisioning of the sale of a service in real-time directly to a customer's CRM or provisioning of the system itself

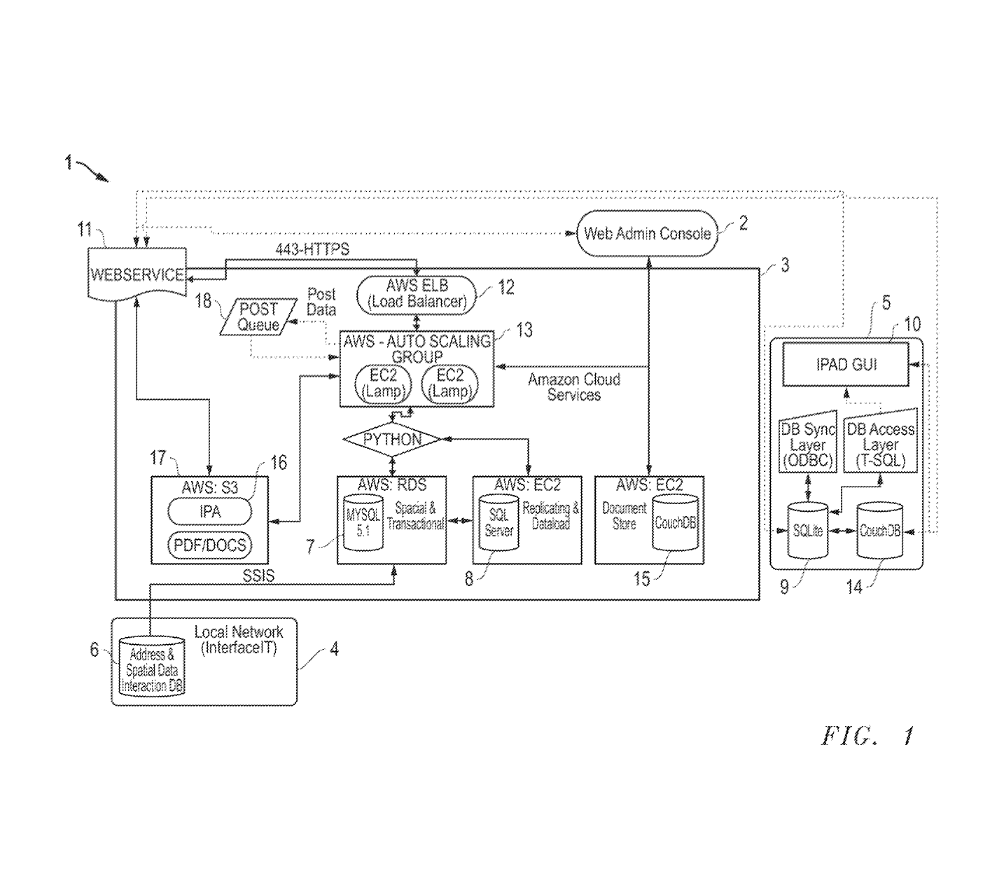

FIGS. 1-10 provide detail and functionality of embodiments of a system for providing customer data requisition and retention profiling for implementation on hand-held computer devices while providing sales personnel with customer requisition and retention data via real-time information for processing transactions in the field during door-to-door sales is shown.

The executed process begins with a client providing a user with a list of customers to prospect and a group to avoid (e.g., do not knock). This data is loaded into a cloud based system and matched to each address for the purposes of displaying a respective icon on each property so that a representative knows how to present in each case. Once this data is loaded, discussions with the client and the managers of the field team occur whereby suburbs or different area segments are selected to target. Generally in the field of the marketing business a ‘Team’ consists of a mobile vehicle and a group of representatives with a ‘Team Manager’ accountable for the team. When areas are selected to target, a Team is designated an area to canvass for one or more days. This is facilitated via a web based system which allows end users to allocate areas to each group of field representatives.

Each field representative is provided a hand-held computer device such as, but not limited to, an Apple® iPad®, which is utilized by the field representative throughout the course of each day to run the application. When initiated, the application method identifies which Team the representative is in, downloads the appropriate suburb data for the day in question, and stores this on the hand-held computer device to utilize. The Team Manager has a view within the application to allocate areas of the suburb or area to individual representatives.

Once the allocation of geographic regions is complete, these appear graphically on the hand-held computer device with the relevant icons to identify whether to inquire with the customer or potential customer, or avoid, a particular address altogether. Each representative can see the address(es) allocated and has the ability to view nearby addresses, search addresses, or access a property directly from the map. In the event that an address is selected, the user is displayed a ‘Customer Information’ screen. This ‘Customer Information’ screen shows all the data that is associated to an address and may include contacts, census descriptions, previous interaction history, and PDF information that may be relevant to the customer and any other information pertinent for the purpose of canvassing. The user at this point completes an interaction with the customer.

In one embodiment, each outcome per interaction may fall into one of the following categories: 1) Sales—The customer accepts the product being sold and the user performs the relevant processes required to complete the Sale; 2) No Sale—The customer receives a presentation and decides against the purchase of the product; 3) No Presentation—The user is unable to present to a customer; and 4) Reschedule—The user presents to the customer but is unable to finalize the Sale and needs to set an appointment. These interaction outcomes are stored to the cloud database for the purposes of providing real-time reporting to management (something which has been unavailable to management in the past due to the reliance on paperwork in field of marketing). The particular type of outcomes is customizable via the central web administrative console or web management. For example, the client may wish to customize its forms appearing on the iPad® graphical interface for an outcome per interaction.

Referring to FIG. 1, a customer relationship management system 1 (CRM) of the present invention is shown. CRM 1 comprises a web administrator console 2, a cloud computing platform 3 for remote computing services, a local network 4, and a hand-held computing device 5 such as but not limited to the Apple® iPad®. Address and spatial data is stored on a database 6 within the local network 4. Said address and spatial data from database 6 is pulled from the local network 4 onto a MYSQL (or similar database) database 7 within the cloud computing platform 3. Spatial data from the MYSQL database 7 is transferred to and from the SQL server 8 (or similar database) within the cloud computing platform 3 for the purpose of reporting, i.e. data replicating and processing. Data may also originate from the web console 2 or the SQLite (or similar database) database 9 within the hand-held device 5. The data from the web administrator console 2, such as data used to create forms for use on the graphical user interface 10 of the hand-held device 5, is transferred through the web service 11 and through the load balancer 12 within the cloud computing platform 3. The load balancer 12 functions to allow the bandwidth to be scaled up or down with demand. This data then goes into the cloud computing platform elastic compute cloud 13, which is a web service that allows computing and applications. This data is then stored in the MYSQL and SQL server databases 7 and 8. Data from the SQLite database 9 within the hand-held device 5 is transferred through the web service 11 onto the cloud computing services 3 through the load balancer 12 and processed via the elastic cloud computing framework 13 and into the MYSQL database 7 and SQL server database 8. All data is routed through the POST Queue 18 prior to being sent to the databases 7 and 8. This ensures that, in the event an error is received, all other incoming data is not lost and is simply held in the queue until the error is repaired. This acts as a failsafe to ensure data is not lost. Documents such as pdfs, videos, images, and URLs are stored in a CouchDB 14 (or similar database) on the hand-held device 5. These documents are transferred from the CouchDB 14 through the web service and then through the elastic compute cloud 13 and into the document database 15. There is also a document store within the cloud computing platform 3. This document store is a CouchDB 15 (or similar database) in which documents such as pdfs, videos, images, and URLs are stored and may be uploaded to or downloaded from the web admin console 2 and then be transferred through the web service 11 and onto the hand-held device 5 where said documents are stored in the CouchDB 14. Also within the cloud computing platform 3 the actual hand-held device application 16 is stored on a storage system 17.

Reporting is provided via the web console 2. The web console 2 comprises modules that enable a user to create other users, allocate other users to a team, specify and allocate a suburb to a team schedule, create forms for each type of interaction, and other functions.

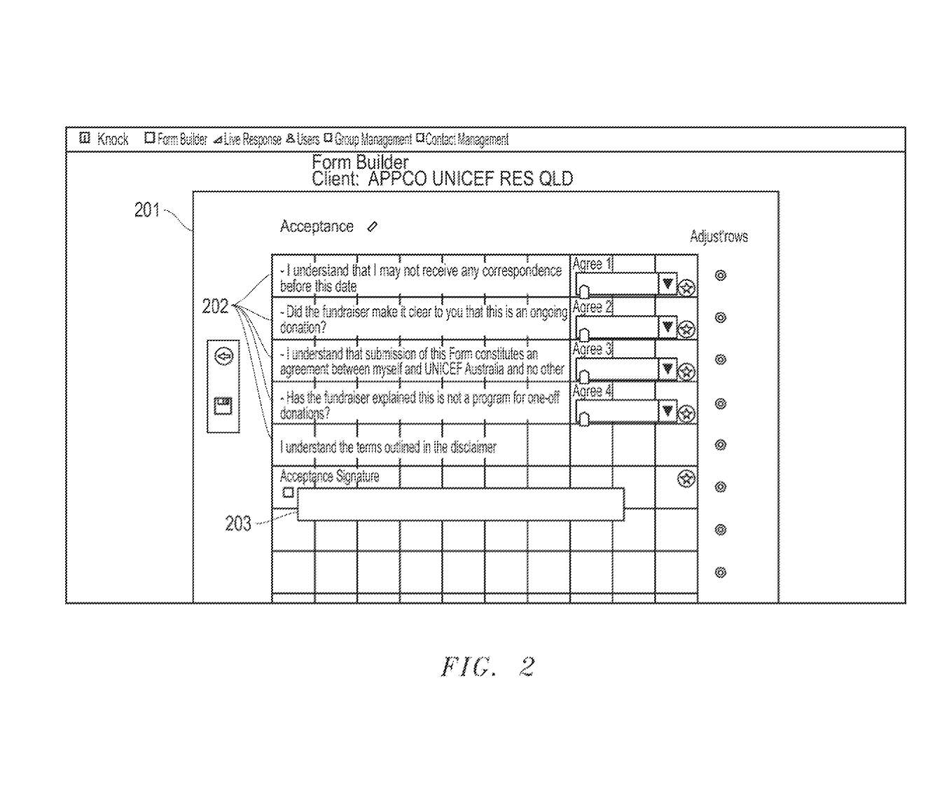

FIG. 2 shows the form builder module 201 within the web console 2. Within the form builder 201, the user is able to create, edit, and save customizable forms to appear on the iPad® graphical user interface 10. For example, in FIG. 2 the user is able to specify a number of questions 202 that the customer must answer or respond to during a customer interaction as well as provide a form field for capturing the customer's signature (203).

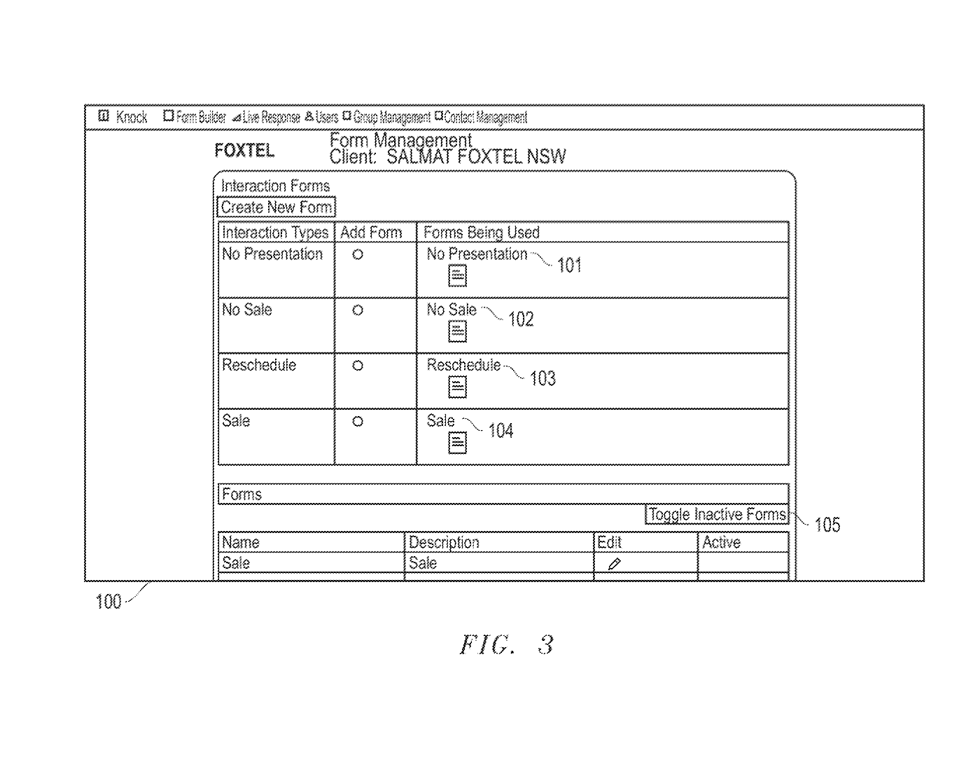

FIG. 3 shows a form management module 100 within the web console 2. In this form management module 100 a user can create and manage different forms for different interaction types. Forms can be created for all types of customer interactions. For example, if there was no presentation to a particular customer 101, if there was not sale 102, if they need to reschedule 103, or if there was a sale 104. The user may activate and deactivate forms 105 via the web console 2.

In the event of a sale, the application may enable the user to provide product information to the customer, and capture the necessary data required to complete the provision of the sale. This may include validation of required fields, digital signatures, financials, verbal verifications and other associated information. All information within the device is cached to the hand-held computer device, meaning that as long as a user downloads the data with connectivity, the application will continue to run without the need for an internet connection for 90% of the available functions.

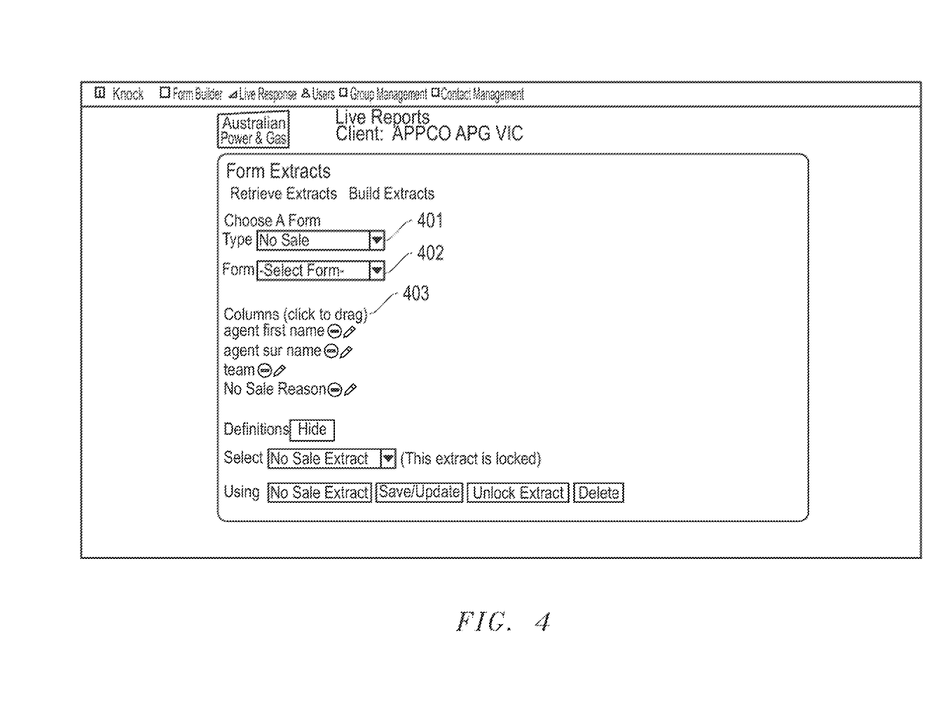

FIG. 4 shows the user interface within the web console 2 for creating live reports. The user can select a type of interaction 401 and form 402 as well as different columns or entries 403 from the forms in order to aggregate data captured by sales representatives via the hand-held device 5. The user on the web console 2 can then create reports or graphical representations of this data.

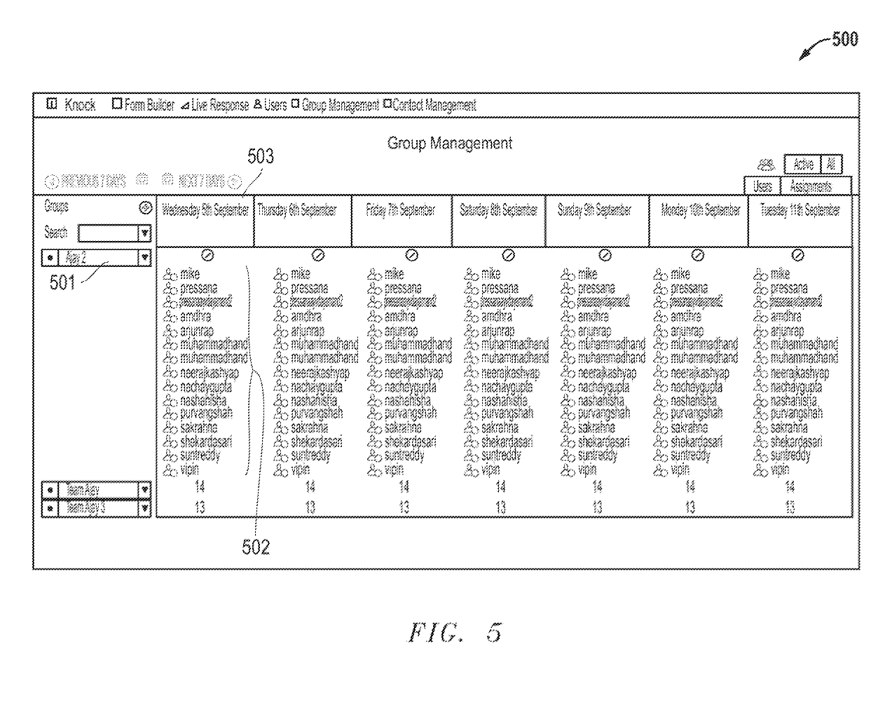

FIG. 5 shows a group management module 500 within the web console 2 in which the user can create other users, allocate sales representatives to a team, specify and allocate a spatial area to a team, and/or specific sales representatives. For example, in FIG. 5 each team 501 has a group of representatives 502 for a specified day 503.

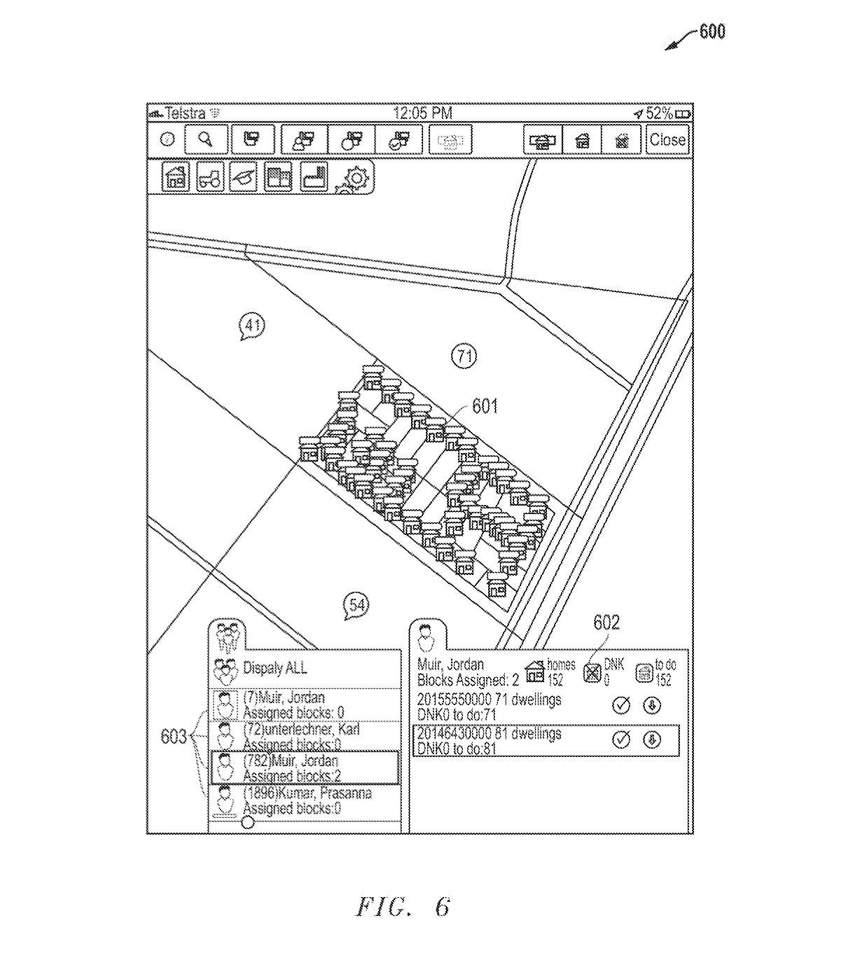

FIG. 6 shows an allocation module 600 on the graphical user interface on the hand-held device 5. This module 600 provides team managers with the ability to allocate geographic regions to groups of representatives and view said allocations. For example, a team manager can click on the icon for a particular sales representative 603 and determine the geographical regions assigned to said sales representative, the number of dwellings within that geographic area, and which dwellings have been allocated as do not knock properties 602. For each sales representative 603, an icon is shown and may be selected. When the icon is selected for each sales representative, the said sales representative geographical allocation is shown graphically on the user interface.

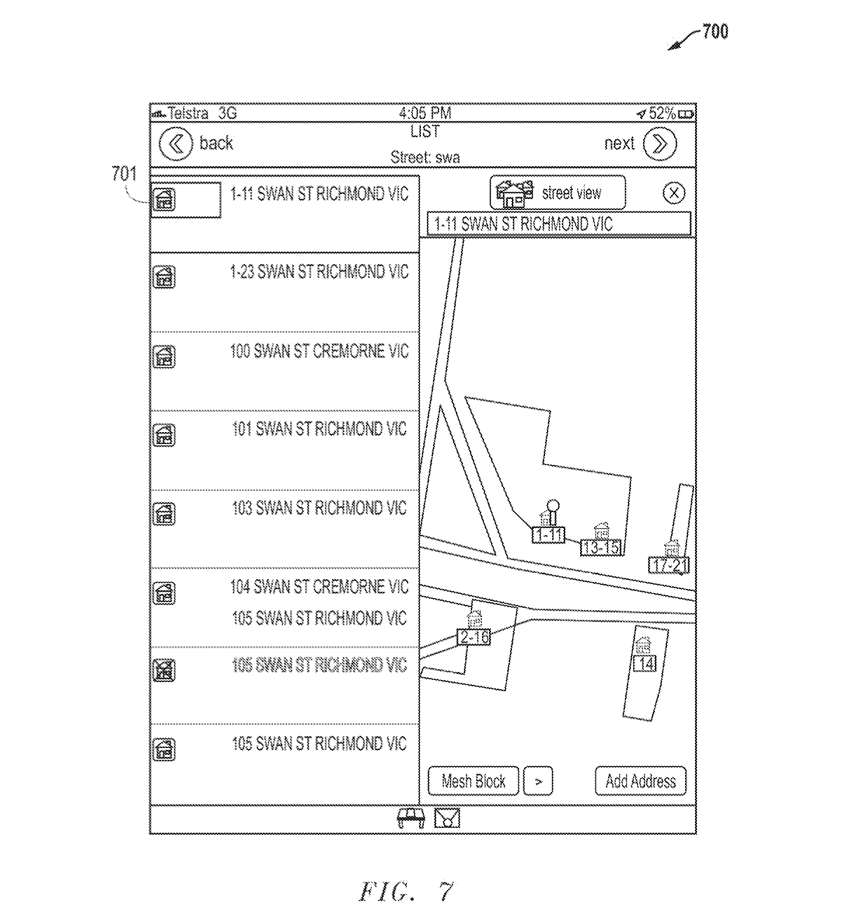

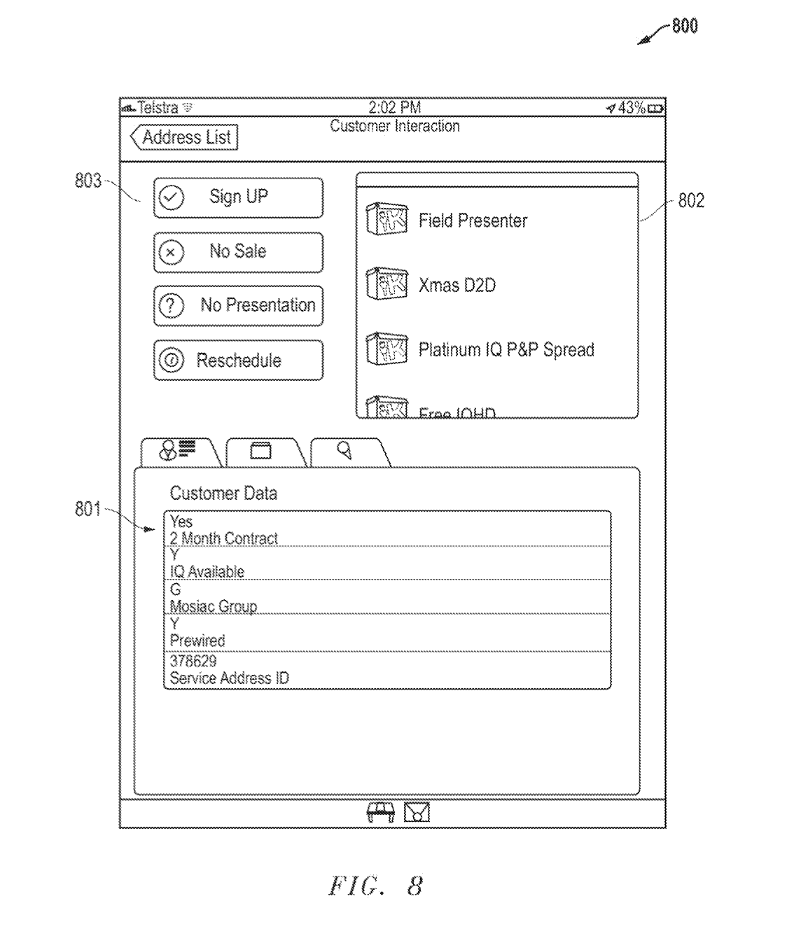

FIG. 7 represents a mapping module 700 on the graphical user interface 10 of the hand-held device 5 in which a user can select an address from a particular geographic allocation in order to view customer data related to that address. Once the user taps on said address 701, the customer data module of FIG. 8 is displayed on the graphical user interface 10 of the hand-held device 5. This module 800 displays customer data 801 as well as geographic and demographic customer information. The module of FIG. 8 may also provide the user with real time sales opportunity information 802 such as which products are available to be sold to the particular customer in that particular area. The user may select a particular product from the product listing 802 on the graphical user interface and a pop-up displaying information or data about the particular product may be displayed on the graphical user interface. Also, in this customer interaction module 800 of FIG. 8, a user or sales representative is able to select an action (i.e., “Sign Up,” “No Sale,” “No Presentation,” “Reschedule”) depending on what happens during the customer interaction. For example, if the customer decides that he wants to make a purchase based on the user's sales presentation, the user can select the “Sign Up” option 803, and the user will then be led through a series of customized forms in order to sign up that customer for that particular product.

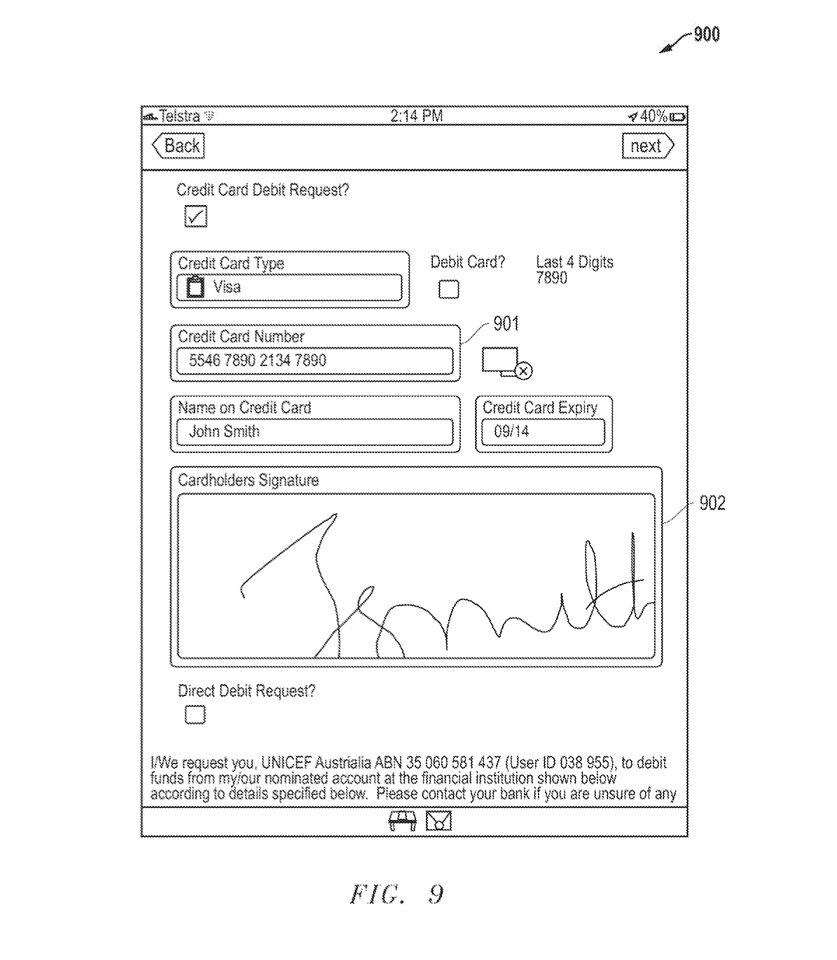

For example, a credit card information form 900 as shown in FIG. 9 may be displayed in which the user can enter, or hand off the hand-held device 5 to the customer to enter, a credit card number 901 and other credit card information as well as the customer's signature 902. The customer interaction module 800 may also display suggestions for possible up-sell and cross-sell opportunities. It also may display certain flags or indicators showing the customer's spending habits or quality of customer (payment timeliness).

The system may also be equipped with a help desk functionality with relevant operating manuals. The helpdesk provides the ability to communicate directly with an IT team in the event that a bug or an issue is experienced in the field.

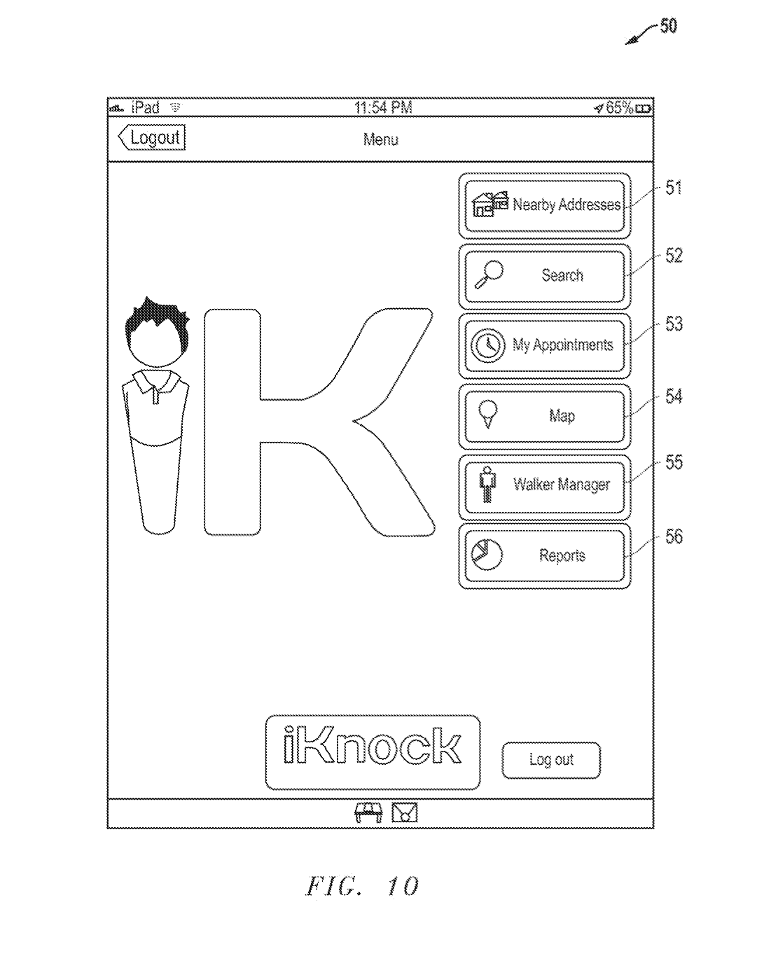

FIG. 10 shows a main menu module 50 of the graphical user interface 10 on the hand-held device 5. From this main menu module 50, the user is able to select an option depending upon what he or she wants to do. For example, if the user wants to look at data from nearby properties, he or she can select the “Nearby Addresses” button 51. If the user would like to search for an address, he or she can select the “Search” button 52. If the user wants to look at his or her upcoming appointments, he or she can look at the “My Appointments” button 53. If the user wants to look at a map of his or her current location and surroundings, he or she can select the “Map” button 54, and if the user is a team manager and wants to look at all of his or her sales representatives' locations, allocations, and/or performance, he or she can select the “Walker Manager” button 55. If the user wants to create or view reports with data captured from sales representatives, he or she can select the “Reports” button 56.

What is claimed is:

1. A system comprising:
a computing device;
an enterprise grade computer application, wherein the application processes transactions in the field while sales representatives facilitate door-to-door sales, wherein the system provides for the allocation of geographical regions to groups of representatives, provides representatives with view capability regarding said allocations, provides accessibility to property data, provides for the display of information at the point-of-sale, provides for the capture and storage of information including digital signatures and verbal verifications, and provides for the storage of data related to the outcome of an interaction.

2. The system of claim 1 wherein the application provides for the graphical display of data related to the location and performance of said representatives.

3. The system of claim 1 wherein the application provides for the display of forms prepopulated with stored or acquired data.

4. The system of claim 1 wherein the application provides for the acquisition of geographical data of all digital signatures and verbal verifications.

5. The system of claim 1 wherein the application provides for the accessibility to property data comprising customer profiling data, demographic data, geographic data, historic interaction data, and credit data.

6. The system of claim 1 wherein the application provides for the display of product information based on availability in the particular geographic area.

7. The system of claim 1 wherein the application provides for the suggestion of up-sell and cross-sell opportunities for a particular customer.

8. The system of claim 1 wherein the application provides for the graphical display of statistics such as penetration of a particular geographic area, number of sales within a geographic area, and land use within a geographic area.

9. The system of claim 1 wherein the application provides for communication between sales personnel and team managers.

10. A method comprising:
providing a computing device;
providing an enterprise grade computer application, wherein the application processes transactions in the field while sales representatives facilitate door-to-door sales, wherein the method provides for the allocation of geographical regions to groups of representatives, provides representatives with view capability regarding said allocations, provides accessibility to property data, provides for the display of information at the point-of-sale, provides for the capture and storage of information including digital signatures and verbal verifications, and provides for the storage of data related to the outcome of an interaction.

11. The method of claim 10 further providing for the graphical display of data related to the location and performance of said representatives.

12. The method of claim 10 further providing for the display of forms prepopulated with stored or acquired data.

13. The method of claim 10 further providing for the acquisition of geographical data of all digital signatures and verbal verifications.

14. The method of claim 10 further providing for the accessibility to property data comprising customer profiling data, demographic data, geographic data, historic interaction data, and credit data.

15. The method of claim 10 further providing for the display of product information based on availability in the particular geographic area.

16. The method of claim 10 further providing for the suggestion of upsell and cross-sell opportunities for a particular customer.

17. The method of claim 10 further providing for the geographical display of statistics such as penetration of a particular geographic area, number of sales within a geographic area, and land use within a geographic area.

18. The method of claim 10 further providing for communications between sales personnel and team manager.
